(19) United States
(12) Patent Application Publication
(10) Pub. No.: US 2003/0068047 A1
(43) Pub. Date: Apr. 10, 2003

(54) One-way broadcast key distribution

(76) Inventors: David A. Lee, Beaverton, OR (US); Michael S. Ripley, Hillsboro, OR (US)

Correspondence Address: BLAKELY, SOKOLOFF,, TAYLOR & ZAFMAN LLP, Seventh Floor, 12400 Wilshire Boulevard, Los Angeles, CA, 90025-1026, US

(21) Appl. No.: 09/966,777

(22) Filed: Sep. 28, 2001

(51) Int. Cl. H04L 9/00

(52) U.S. Cl. 380/278

(57) ABSTRACT

A method and apparatus are described for a one-way broadcast distribution of keys for decrypting encrypted broadcast content. According to one embodiment of the present invention, a method and apparatus are described for generating a list of update keys on a content provider system based on a table of secret keys associated with a plurality of content receivers. The list of update keys is generated in a manner to allow valid receivers to recover a valid content key while invalid receivers recover an invalid content key. The list of update keys are used to generate a multiple nested list of decryption patterns that is broadcast to all receivers. The receivers then recover an appropriate set of update keys for each receiver from the multiple nested list of decryption patterns so that the final key recovered in the set of update keys is a content key.

### FIELD OF THE INVENTION

The invention relates generally to the field of data encryption. More particularly, the invention relates to a one-way broadcast distribution of keys.

### BACKGROUND OF THE INVENTION

Providers of digital content of various types frequently broadcast this content via various media. Examples of the type of content include music, multimedia presentations, text, television content, software, and other forms of digital data. Types of broadcasts can include various forms of over-the-air broadcasts, copper wire or fiber optic cable based network broadcasts, or even distribution of recordable media such as magnetic or optical disks. Regardless of the media used, all of these types of broadcasts are one-way distributions of content.

When distributing content in such a manner, the content provider frequently wishes to encrypt the content to prevent unauthorized persons from receiving the content. The problem is, the keys for decrypting the content must be sent to the receiver also. Frequently, this key is broadcast along with the content. Unfortunately, interception of this key then becomes relatively easy. Additionally, cracking the key to provide unauthorized access to the content, while possibly time consuming, also becomes relatively easy.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating a high-level view of a system for one-way broadcast key distribution according to one embodiment of the present invention;

FIG. 2 is a block diagram of a key distribution center system according to one embodiment of the present invention;

FIG. 3 is a block diagram of a receiver system according to one embodiment of the present invention;

FIG. 4 is a flowchart illustrating a high-level view of one-way broadcast key distribution according to one embodiment of the present invention;

FIG. 5 is a flowchart illustrating key distribution center processing according to one embodiment of the present invention;

FIG. 6 is a flowchart illustrating an update key generation process according to one embodiment of the present invention;

FIG. 7 is a flowchart illustrating receiver processing according to one embodiment of the present invention; and

FIG. 8 is a flowchart illustrating a list parsing process according to one embodiment of the present invention.

### DETAILED DESCRIPTION OF THE INVENTION

A method and apparatus are described for a one-way broadcast distribution of keys for decrypting encrypted broadcast content. According to one embodiment of the present invention, a method and apparatus are described for generating a list of update keys on a content provider system based on a table of secret keys associated with a plurality of content receivers. The list of update keys is generated in a manner to allow valid receivers to recover a valid content key while invalid receivers recover an invalid content key. The list of update keys are used to generate a multiple nested list of decryption patterns that is broadcast to all receivers. The receivers then recover an appropriate set of update keys for each receiver from the multiple nested list of decryption patterns so that the final key recovered in the set of update keys is a content key.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to a broadcast of content such an over-the-air broadcast or network broadcast, the method and apparatus described herein are equally applicable to other forms of content distribution. For example, the techniques described herein are thought to be useful in connection with the distribution of content on optical or magnetic recordable media such as compact disks.

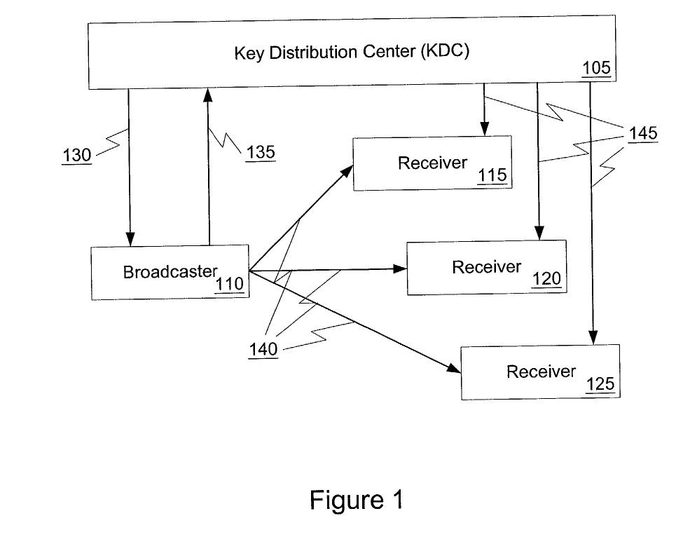

FIG. 1 is a block diagram illustrating a high-level view of a system for one-way broadcast key distribution according to one embodiment of the present invention. This system includes a Key Distribution Center (KDC) 105, a broadcaster 110, and a number if receivers 115, 120, and 125. In this example, the broadcaster 110 is intending to broadcast 140 encrypted content to the receivers 115-125. This broadcast 140 may occur over a variety of media. For example, the broadcast 140 may be an over-the-air broadcast, or may be sent over a network of copper wire or fiber optic cable. In another situation, content may be distributed on magnetic or optical recordable medium such as a compact disk. In any case, encrypted content is transferred from the broadcaster 110 to the receivers 115-125 in a one-way, one-to-many manner.

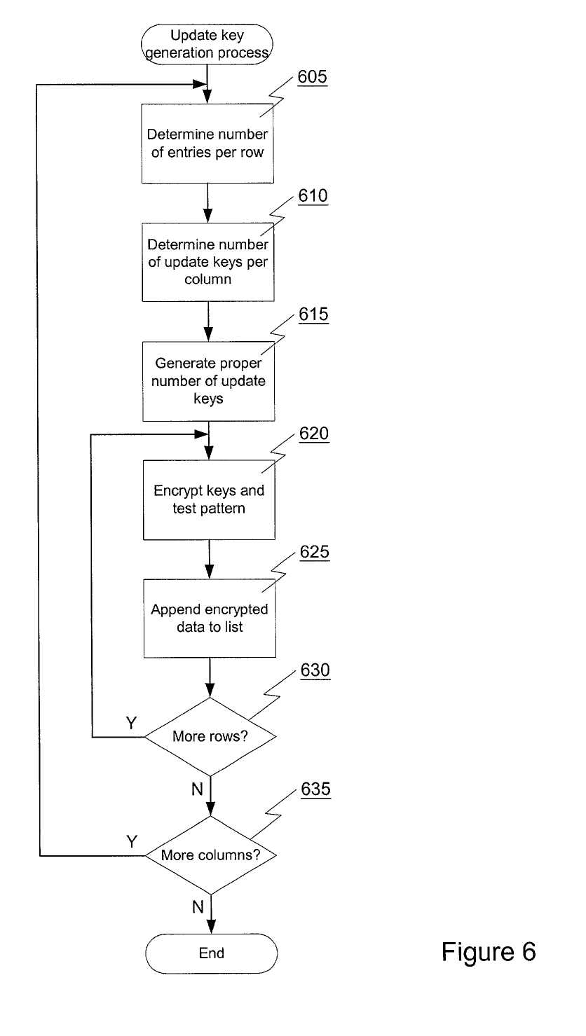

If all receivers are eligible to receiver the content, one key, known to both the broadcaster 110 and the receivers 115-125, may be used. However, not all of the receivers 115-125 may be eligible to receive the content. For example, one of the receivers may not have paid a subscription fee for a particular piece of content or may have been altered or hacked in some manner. If known to the broadcaster 110, the unauthorized or “bad” receiver may be blocked from receiving some or all content. In order to block unauthorized receivers, the broadcaster 110 identifies bad receivers and notifies 135 the KDC 105 of their identity. Alternatively, another entity, such as a licensing agent or the even the KDC 105, handles the task of identifying bad receivers. Regardless of who identifies the bad receivers, the KDC 105 maintains a table of secret keys for all receivers 115-125 in the system. The KDC then generates a list of update keys based on the table of secret keys. Details of how this list may be generated are discussed below with reference to FIG. 6. Generally, the list of update keys is generated in a manner to allow valid, authorized receivers to recover a valid content key while invalid, unauthorized receivers recover an invalid content key. In other words, the KDC 105 generates a chain of intermediate update keys. Depending on whether the keys are intended for a valid or invalid receiver, the chain leads to a valid or invalid content key.

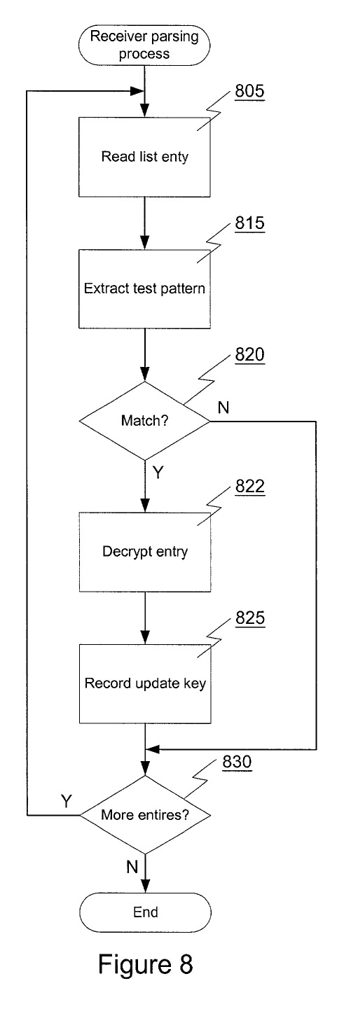

The update keys are then used to generate a multiple nested list of decryption patterns that contains versions of the update keys encrypted using the secret keys assigned to each receiver. Therefore, the update keys themselves are protected through this encryption. The multiple nested list of decryption patterns is broadcast 145 from the KDC 105 to all receivers 115-125. The receivers 115-125 then recover an appropriate set of update keys for each receiver 115-125 from the multiple nested list of decryption patterns so that the final key recovered in the set of update keys is a content key. Details of how these keys may be recovered are discussed below with reference to FIG. 8. Additionally, the KDC sends 130 the content key to the broadcast 110 for use in encrypting content to be sent to the receivers. Alternatively, the content key may be generated by another entity. For example, the broadcaster or a third party may generate the content key as long as the key can be shared by the broadcaster and KDC. Broadcast content may be encrypted with the content key using any of a variety of well-known encryption techniques.

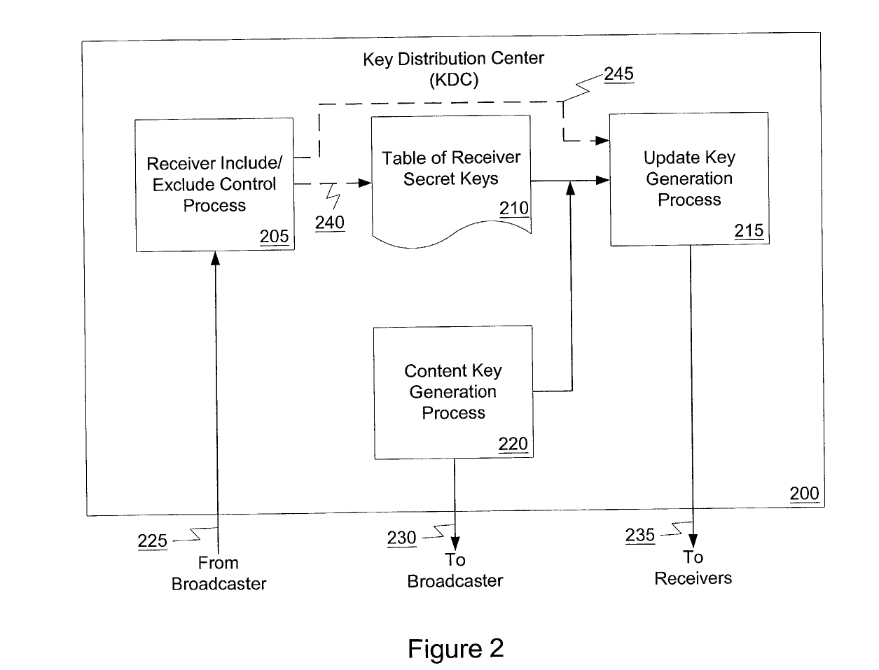

FIG. 2 is a block diagram of a key distribution center system according to one embodiment of the present invention. In this example, a key distribution center (KDC) system 200 receives 225, from a broadcaster, an indication of which receivers to exclude from a coming broadcast. As mentioned above, in alternative embodiments, another entity, such as a licensing agent or the even the KDC 200, handles the task of identifying bad receivers. This indication may be in the form of a list of identifiers uniquely identifying bad receivers. This indication is then used by a process 205 within the KDC system 200 that controls the inclusion or exclusion of particular receivers. This process 205 may, in some manner, indicate or flag bad receivers in the table of receiver secret keys 210. Alternatively, the receiver include/exclude control process 205 may directly influence the update key generation process 215 rather than writing an indication to the table of receiver secret keys 210.

The table of receiver secret keys 210, in the following simple example, has the dimension of 2×2.

| | |
|---|---|
| K_{0,0} | K_{1,0} |
| K_{0,1} | K_{1,1} |

Using this table, each receiver can be assigned one key from each column. The combination of these keys then uniquely identifies that receiver. For example, with this table, four possible receivers can be identified. They are the receivers identified by the combination of secret keys K_{0,0} and K_{1,0}, K_{0,0} and K_{1,1} , K_{0,1} and K_{1,0} and K_{0,1} and K_{1,1}. Of course, larger tables would be used in actual implementations. Additionally, various numbers of rows and columns may be used depending on the particular application.

The content key generation process 220 generates a content key to be used in encrypting and decrypting a future broadcast of content. The key is sent 230 to a broadcaster for encrypting the content and is used by the update key generation process 215. This process 220 can randomly generate a key suitable for use with whatever method is being used to encrypt the content.

The update key generation process 215 generates a list of update keys based on the table of secret keys 210. Details of how this list may be generated are discussed below with reference to FIG. 6. Generally, the list of update keys is generated in a manner to allow valid, authorized receivers to recover a valid content key while invalid, unauthorized receivers recover an invalid content key. In other words, the KDC 105 generates a chain of intermediate update keys. Depending on whether the keys are intended for a valid or invalid receiver, the chain leads to a valid or invalid content key.

The update keys are then used to generate a multiple nested list of decryption patterns that contains versions of the update keys encrypted using the secret keys assigned to each receiver. Therefore, the update keys themselves are protected through this encryption. The multiple nested list of decryption patterns is broadcast from the KDC 105 to all receivers 235.

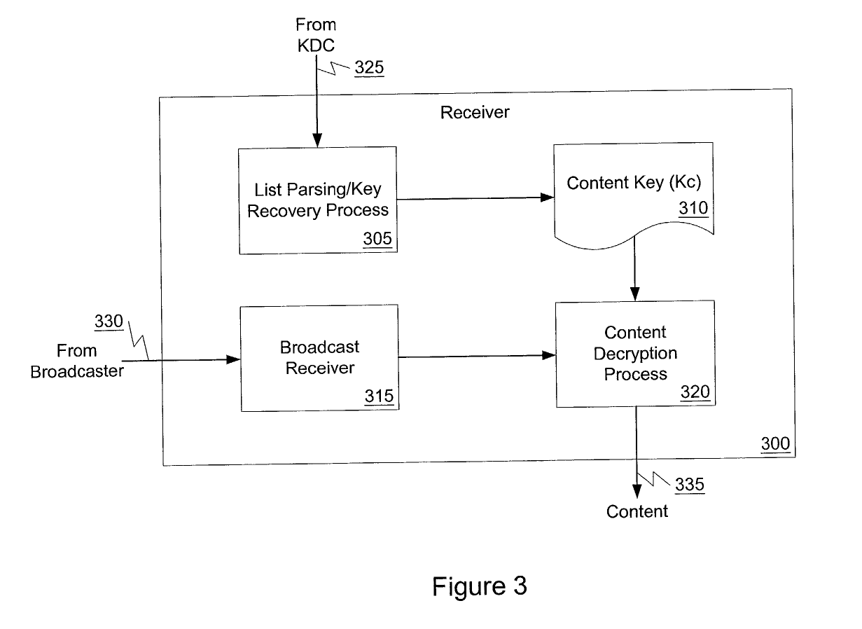

FIG. 3 is a block diagram of a receiver system according to one embodiment of the present invention. In this example, a receiver 300 receives 325 from the KDC a multiple nested list of decryption patterns in which the update keys have been encrypted. A list parsing/key recovery process 305 then reads the list and recovers the update keys intended for this receiver 300. Details of this process 305 will be discussed below with reference to FIG. 8. Generally, the result of this process 305 is a valid content key 310 if the receiver is authorized to receive content. If the receiver 300 is not authorized to receive content, the result of the list parsing/key recovery process is an invalid content key.

A broadcast receiver 315 will receive 330 encrypted content from the broadcaster. Details of this receiver 315 are well-known to those skilled in the art. The receiver 315 may be any type of receiver suitable for receiving transmissions from the broadcast over the applicable medium.

The content decryption process 320 uses the content key 310 to decrypt the content received by the broadcast receiver 315. Assuming a valid content key 310, the content decryption process results in usable content provided 335 to a viewer or end user. As mentioned above with regard to the encryption process of the broadcaster, the decryption process can be the complement of any of the well-known encryption methods that may be used by the broadcaster.

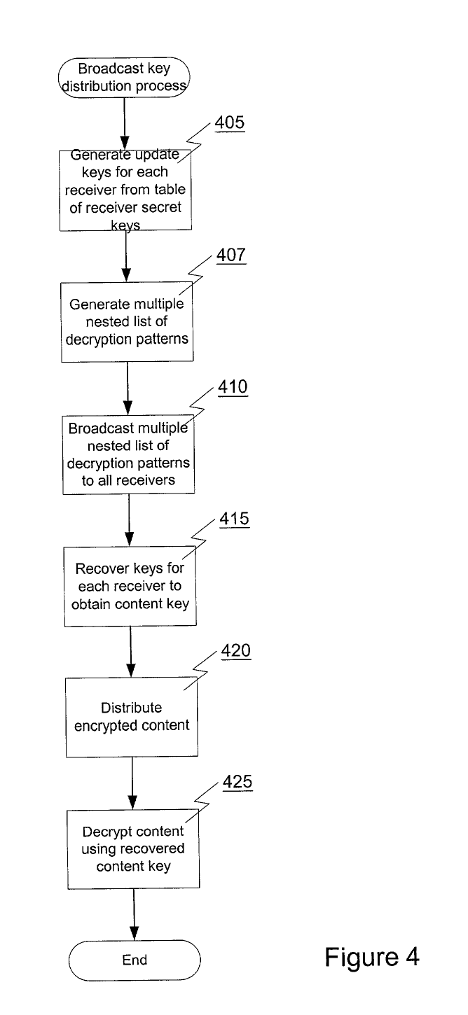

FIG. 4 is a flowchart illustrating a high-level view of one-way broadcast key distribution according to one embodiment of the present invention. Initially, at processing block 405, a list of update keys are generated for each receiver from the table of secret keys stored at the KDC. Details of this process will be described below with reference to FIG. 6. The KDC then, at processing block 407 generates a multiple nested list of decryption patterns that contains versions of the update keys encrypted using the secret keys assigned to each receiver. Next, the KDC broadcasts the multiple nested list of decryption patterns to all receivers at processing block 410. The receivers then, at processing block 415, recover a set of update keys for that receiver in order to obtain the content key. Next, at processing block 420, a broadcaster distributes content encrypted with the content key. Finally, all receivers with a valid content key can decrypt the broadcast content at processing block 425. Alternatively, encrypted content may be broadcast to all receivers prior to or concurrent with broadcast of the multiple nested list of decryption patterns if the content will be cached prior to decryption.

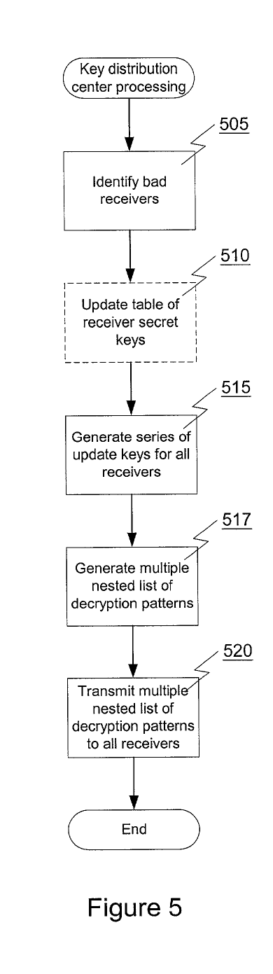

FIG. 5 is a flowchart illustrating key distribution center processing according to one embodiment of the present invention. First, at processing block 505, bad, unauthorized receivers are identified. As explained above, a broadcaster notifies the KDC of which receivers are authorized to receive content and which receivers are not authorized. This notification may be in the form of a list of identifiers. Next, at processing block 510, the KDC may optionally update the table of receiver secret keys. That is, the KDC may flag or otherwise mark entries in the table of secret keys that relate to unauthorized receivers. The KDC then, at processing block 515, generates a list of update keys for all receivers. Details of this process will be described below with reference to FIG. 6. Next, at processing block 517, the KDC generates a multiple nested list of decryption patterns that contains versions of the update keys encrypted using the secret keys assigned to each receiver. Finally, the KDC transmits the multiple nested list of decryption patterns to all receivers at processing block 520.

FIG. 6 is a flowchart illustrating an update key generation process according to one embodiment of the present invention. Basically, this process involves generating a list of data based on a table. As will be easily understood by those skilled in the art, many possible methods can used to accomplish this. The example offered here is provided to illustrate one possible method but is not intended to exclude other possibilities.

In this example, processing begins with the first column of the table. A determination of the number of entries in the list for each row of the column is made at processing block 605. This determination is based on the number of update keys generated for the previous column. For the first column, no previous update keys are used, so, only one entry per row is needed. However, in another column of the table, if three update keys were sent for a previous column, the current column uses three entries per row.

Next, at processing block 610, the number of update keys to be used for this column is determined. This determination is based on the number of possible unauthorized receivers identified by entries in this column. For example, if no unauthorized receivers are identified, only one key is needed. That is, if there are no unauthorized receivers indicated, only a good, valid update key is sent. However, if there are possible unauthorized receivers indicated, a different update key can be generated for each possible bad receiver plus the one update key for good receivers. For example, if the key combinations represented in the current column indicate two possible bad receivers, three update keys are generated, one for good receivers and one each for possible bad receivers indicated in this column.

The proper number of update keys is then generated at processing block 615. As indicated above, the keys can be generated using any of the methods that are well known in the art. In some applications, the keys may be randomly generated. The primary considerations in generating the keys are that they be compatible with the encryption method used and that they are difficult to guess.

At processing block 620, the update keys are encrypted with a key that is a combination of the previous update key, the device secret key associated with this row and column, and table location, using some reversible function such as exclusive or. A test pattern is also provided for the associated previous update key for this entry. The test pattern is a fixed pattern that is known to all receivers. The purpose of the test pattern is to enable the receivers to locate keys intended for that receiver within the list of keys. As will be explained below with reference to FIG. 8, the receivers parse the list, locate keys intended for this receiver at this step based on finding the expected test pattern, and decrypt the associated entries in the list.

At processing block 625, the encrypted update keys are appended to the multiple nested list of decryption patterns. At decision block 630, if more rows exist in the current column, processing returns to processing block 620. That is, keys are generated, encrypted and appended to the list for each row of the current column. At decision block 635, if more columns exist in the table, processing returns to processing block 605. That is, keys are generated for all columns in the table.

Alternatively, if there are no bad receivers to block, the first column is used. That is, only one update key is needed. Generally if any bad receivers are to be blocked, all of the columns are processed. In some embodiments, device key assignments may be grouped in some way to allow use of an intermediate number of columns to block a selected group.

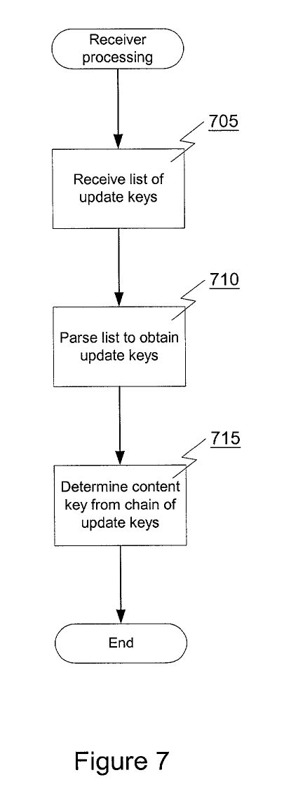

FIG. 7 is a flowchart illustrating receiver processing according to one embodiment of the present invention. First, at processing block 705, the receiver receives the list of update keys from the KDC. Next, the receiver parses the list at processing block 710 to obtain the update keys for that receiver. Details of this process will be described below with reference to FIG. 8. Finally, at processing block 715, the receiver determines the content key from the chain of update keys by using the first update key to decrypt the second and so on until the last key in the chain represents the content key.

FIG. 8 is a flowchart illustrating a list parsing process according to one embodiment of the present invention. Basically, this process involves parsing a list of data. As will be easily understood by those skilled in the art, many possible methods can be used to accomplish this. The example offered here is provided to illustrate one possible method but is not intended to exclude other possibilities.

First, at processing block 805, the receiver reads an entry from the list. The test pattern is extracted from the decrypted data at processing block 815 by performing the compliment function of that used to combine the data at the KDC. If the test pattern extracted from the list entry matches that expected at decision block 820, the entry is decrypted using the receiver's secret keys at processing block 822 and the update key from that list entry is recorded at processing block 825 as being intended for use by this receiver. Finally, at decision block 830, processing returns to processing block 805 if more list entries are present.

To further illustrate the process described above, the following examples are provided. The examples describe a particular manner of reading a table of secret keys, generating a list of update keys and later parsing the list to recover the appropriate update keys. However, this particular method is described only as an example. Other well-known methods of performing these functions may be used.

For a first example, consider a simple case where the KDC maintains a two-by-two array of secret keys as follows:

| | |
|---|---|
| K_{0,0} | K_{1,0} |
| K_{0,1} | K_{1,1} |

With this table, four possible receivers can be identified. They are the receivers identified by the combination of secret keys K_{0,0} and K_{1,0}, K_{0,0} and K_{1,1}, K_{0,1} and K_{1,0}, and K_{0,1} and K_{1,1}. A short-hand, way of representing these combinations is to represent them as a two digit number wherein the first digit represents the row assignment for column zero and the second digit represents the row assignment for column one. So, the four receivers can be identified as:

0,0 representing the receiver with key combination K_{0,0} and K_{1,0};

0,1 representing the receiver with key combination K_{0,0} and K_{1,1};

1,0 representing the receiver with key combination K_{0,1} and K_{1,0}; and

1,1 representing the receiver with key combination K_{0,1} and K_{1,1}.

In a first example, where all receivers are considered good, valid receivers, the KDC can simply send the content key (K_{C}) encrypted with the combination of secret keys for each receiver. That is, the KDC can send a structure to all receivers that contains:

K_{C} encrypted with K_{0,0} and K_{1,0} to receiver 0,0;

K_{C} encrypted with K_{0,0} and K_{1,1} to receiver 0,1;

K_{C} encrypted with K_{0,1} and K_{1,0} to receiver 1,0; and

K_{C} encrypted with K_{0,1} and K_{1,1} to receiver 1,1.

Sent along with the encrypted K_{C} should be an encrypted test pattern. This pattern should be one that is known to all receivers and is used to locate and verify the entries in the list of update keys that are intended for the individual receiver.

In a second, slightly more complex example, one of the four receivers may be considered to be “bad”. That is, the receiver may have been hacked or perhaps a pay subscription has expired, or the receiver may be considered bad for other reasons. In any event, the content provider has determined that this receiver should no longer be authorized to decrypt content. To prevent this unauthorized receiver from receiving the content key K_{C}, intermediate keys are sent to all receivers such that a chain or progression of keys can be formed made up of good keys and bad keys in such a manner that good receivers can ultimately reach K_{C} while bad receivers cannot.

To illustrate, assume that receiver 1,0 has been found to be bad. The receiver can be identified at the KDC by its combination of secret keys. A table or list of keys to be sent to the receivers can be generated based on the array of secret keys stored on at the KDC. A series of intermediate update keys can then be sent to all receivers such that all receivers other than 1,0 receive keys that lead to a valid K_{C} while receiver 1,0 receives keys that result in an invalid combination.

This result can be achieved by building a list of update keys to be encrypted and sent to the receivers based on the table of secret keys stored at the KDC. Various methods of generating this table or list can be used. Likewise, this list may take on various forms while still accomplishing the basic goal of sending a series of encrypted intermediate update keys to all receivers. For the purpose of explanation, start with column 0. In this column, the number of possible bad receivers is indicated by row, column combinations present. In this example, one possible bad receiver is identified, 1,0. Therefore, two update keys should be generated by the KDC, One key (K_{U1}) for good receivers and one key (K_{U2}) for possibly bad receivers. Then, written into the table or list is:

Col. 0 row 0 gets K_{U1} encrypted with K_{U0}

Col. 0 row 1 gets K_{U2} encrypted with K_{U0}

Actually, K_{U1}, for example, is encrypted with the value obtained by combining K_{U0}, K0,0, and the table index as explained above. However, for clarity, this example simply uses K_{U0}.

Moving on to column 1, two possible keys have previously been used when building the list for column 0, K_{U1} and K_{U2}. So, there should be two list entries per row of column 1. Also, this is the last column of the table so receivers that are considered to be good receivers should be sent K_{C}. So, two keys can be sent, K_{U3} to bad receivers and K_{C} to good receivers. Col. 1, row 0 gets K_{C} or K_{U3} depending on column 0 and col. 1, row 1 gets K_{C}. The list then becomes:

Col. 1, row 0 gets K_{C} encrypted with K_{U1}

Col. 1, row 0 gets K_{U3} encrypted with K_{U2}

Col. 1, row 0 gets K_{C} encrypted with K_{U1}

Col. 1, row 0 gets K_{C} encrypted with K_{U2}

So, when the receivers parse the list of update keys and find the update keys based on a match of the test pattern, each receiver will have a series of three keys as follows:

Receiver 0,0 gets keys K_{U0}, K_{U1}, and K_{C}

Receiver 0,1 gets keys K_{U0}, K_{U1}, and K_{C}

Receiver 1,0 gets keys K_{U0}, K_{U2}, and K_{U3}

Receiver 1,1 gets keys K_{U0}, K_{U2}, and K_{C}

As a result, all good receivers end up with a combination of keys that result in a valid K_{C} while the bad receiver, receiver 1,0, ends up with a combination of keys that results in something other than a valid K_{C}.

In another, slightly more elaborate example, a table of 3 columns and 3 rows may be maintained by the KDC. For example:

| | | |
|---|---|---|
| K_{0,0} | K_{1,0} | K_{2,0} |
| K_{0,1} | K_{1,1} | K_{2,1} |
| K_{0,2} | K_{1,2} | K_{2,2} |

This table provides 3³ or 27 possible receivers that can be identified by various combinations of secret keys in the 3 columns. Using the short hand explained above, wherein the first digit represents the row assignment of the first column and so on, the receivers identified are:

| | | |
|---|---|---|
| 0,0,0 | 1,0,0 (bad) | 2,0,0 |
| 0,0,1 | 1,0,1 | 2,0,1 (bad) |
| 0,0,2 | 1,0,2 | 2,0,2 |
| 0,1,0 | 1,1,0 | 2,1,0 |
| 0,1,1 | 1,1,1 | 2,1,1 |
| 0,1,2 | 1,1,2 | 2,1,2 |
| 0,2,0 | 1,2,0 | 2,2,0 |
| 0,2,1 | 1,2,1 | 2,2,1 |
| 0,2,2 | 1,2,2 | 2,2,2 |

As indicated, assume that receivers 1,0,0 and 2,0,1 are determined to be bad. All other receivers are considered good, valid receivers.

So, in generating a list of update keys for the receiver, the KDC may begin with column 0. Looking at this column, two possible bad receivers, 1,0,0 and 2,0,1, are identified along with numerous good receivers. Therefore, 3 update keys will be generated, K_{U1}, K_{U2}, and K_{U3}. Receivers identified with column 0 row 0, all of which are good receivers, will get K_{U1}. Receivers identified with column 0 row 1 or row 2 may be bad receivers and will get update keys K_{U2} or K_{U3}. So, the list of update keys becomes:

Col. 0 row 0 gets K_{U1} encrypted with K_{U0}

Col. 0 row 1 gets K_{U2} encrypted with K_{U0}

Col. 0 row 2 gets K_{U3} encrypted with K_{U0}

Moving on to column 1, there are 3 possible update keys generated based on column 0, so, each row of column 1 will have 3 entries. Additionally, there should be three possible update keys generated for column 1. One update key, K_{U4}, will be for the good receivers identified in rows 1and 2, one update key, K_{U5}, will be for the first possible bad receivers path identified in row 0, and one update key, K_{U6}, will be the update key for the bad path from the previous column for row 2. So, the list becomes:

Col. 1 row 0 gets K_{U4} encrypted with K_{U1}

Col. 1 row 0 gets K_{U5} encrypted with K_{U2}

Col. 1 row 0 gets K_{U6} encrypted with K_{U3}

Col. 1 row 1 gets K_{U4} encrypted with K_{U1}

Col. 1 row 1 gets K_{U4} encrypted with K_{U2}

Col. 1 row 1 gets K_{U4} encrypted with K_{U3}

Col. 1 row 2 gets K_{U4} encrypted with K_{U1}

Col. 1 row 2 gets K_{U4} encrypted with K_{U2}

Col. 1 row 2 gets K_{U4} encrypted with K_{U3}

Moving on to column 2, there are three possible update keys coming into this column, K_{U4} K_{U5}, and K_{U6}. Therefore, each row of column 2 will have three entries in the list. Additionally, this is the last column of the table. So, good receivers will receive K_{C} while bad receives will receive something other than a valid K_{C}. In this example, bad receivers will be given K_{U}. The KDC then generates a list of update keys as follows:

Col. 2 row 0 gets K_{C} encrypted with K_{U4}

Col. 2 row 0 gets K_{C} encrypted with K_{U5}

Col. 2 row 0 gets K_{U7} encrypted with K_{U6}

Col. 2 row 1 gets K_{C} encrypted with K_{U4}

Col. 2 row 1 gets K_{U7} encrypted with K_{U5}

Col. 2 row 1 gets K_{C} encrypted with K_{U6}

Col. 2 row 2 gets K_{C} encrypted with K_{U4}

Col. 2 row 2 gets K_{C} encrypted with K_{U5}

Col. 2 row 2 gets K_{C} encrypted with K_{U6}

So, when the receivers parse the list of update keys and find the update keys based on a match of the test pattern, each receiver will have a series of three keys as follows:

Receiver 0,0,0 gets keys K_{U0}, K_{U1}, K_{U4} and K_{C}

Receiver 0,0,1 gets keys K_{U0}, K_{U1}, K_{U4} and K_{C}

Receiver 0,0,2 gets keys K_{U0}, K_{U1}, K_{U4} and K_{C}

Receiver 0,1,0 gets keys K_{U0}, K_{U1}, K_{U4} and K_{C}

Receiver 0,1,1 gets keys K_{U0}, K_{U1}, K_{U4} and K_{C}

Receiver 0,1,2 gets keys K_{U0}, K_{U1}, K_{U4} and K_{C}

Receiver 0,2,0 gets keys K_{U0}, K_{U1}, K_{U4} and K_{C}

Receiver 0,2,1 gets keys K_{U0}, K_{U1}, K_{U4} and K_{C}

Receiver 0,2,2 gets keys K_{U0}, K_{U1}, K_{U4} and K_{C}

Receiver 1,0,0 gets keys K_{U0}, K_{U2}, K_{U6} and K_{U7} (bad)

Receiver 1,0,1 gets keys K_{U0}, K_{U2}, K_{U6} and K_{C}

Receiver 1,0,2 gets keys K_{U0}, K_{U2}, K_{U6} and K_{C}

Receiver 1,1,0 gets keys K_{U0}, K_{U2}, K_{U5} and K_{C}

Receiver 1,1,1 gets keys K_{U0}, K_{U2}, K_{U5} and K_{C}

Receiver 1,1,2 gets keys K_{U0}, K_{U2}, K_{U5} and K_{C}

Receiver 1,2,0 gets keys K_{U0}, K_{U2}, K_{U4} and K_{C}

Receiver 1,2,1 gets keys K_{U0}, K_{U2}, K_{U4} and K_{C}

Receiver 1,2,2 gets keys K_{U0}, K_{U2}, K_{U4} and K_{C}

Receiver 2,0,0 gets keys K_{U0}, K_{U3}, K_{U5} and K_{C}

Receiver 2,0,1 gets keys K_{U0}, K_{U3}, K_{U5} and K_{U7} (bad)

Receiver 2,0,2 gets keys K_{U0}, K_{U3}, K_{U5} and K_{C}

Receiver 2,1,0 gets keys K_{U0}, K_{U3}, K_{U4} and K_{C}

Receiver 2,1,1 gets keys K_{U0}, K_{U3}, K_{U4} and K_{C}

Receiver 2,1,2 gets keys K_{U0}, K_{U3}, K_{U4} and K_{C}

Receiver 2,2,0 gets keys K_{U0}, K_{U3}, K_{U4} and K_{C}

Receiver 2,2,1 gets keys K_{U0}, K_{U3}, K_{U4} and K_{C}

Receiver 2,2,2 gets keys K_{U0}, K_{U3}, K_{U4} and K_{C}

As a result, good receivers end up with a chain of update keys resulting in a valid content key while bad receivers 1,0,0 and 2,0,1 end up with an invalid content key.

What is claimed is:

1. A method comprising:
generating a list of update keys on a key distribution center system based on a table of secret keys identifying valid and invalid receivers of a plurality of receivers, said list of update keys allowing valid receivers to decrypt a valid content key using update keys obtained from the list of update keys;
generating a multiple nested list of decryption patterns based on the list of update keys;
broadcasting said multiple nested list of decryption patterns to the plurality of receivers;
recovering a content key from the list of update keys by recovering a set of update keys for each receiver from the multiple nested list of decryption patterns and using the set of update keys to decrypt the content key.

2. The method of claim 1, wherein said generating a list of update keys comprises generating at least one intermediate key and one content key.

3. The method of claim 2, wherein said generating at least one intermediate key and one content key comprises randomly generating said at least one intermediate key and one content key.

4. The method of claim 3, wherein authorized receivers will receive an intermediate key that allows recovery of a valid content key and unauthorized receivers will receive an intermediate key that does not allow recovery of a valid content key.

5. The method of claim 1, wherein said generating a multiple nested list of decryption patterns comprises encrypting an entry of the list of update keys using a key that is a combination of a previous update key, a secret key for a receiver associated with the entry of the list of update keys, and an index indicating a location in said table of secret keys associated with each entry.

6. The method of claim 5, wherein an entry in said multiple nested list of decryption patterns includes a predetermined test pattern encrypted with the secret keys for a receiver associated with the entry of the list of update keys.

7. The method of claim 1, wherein said recovering a set of update keys for each receiver from the multiple nested list of decryption patterns comprises parsing said multiple nested list of decryption patterns to locate an entry intended for a particular receiver based on detection of a predetermined test pattern included in an entry in the multiple nested list of decryption patterns.

8. The method of claim 1, further comprising broadcasting content encrypted with said content key.

9. The method of claim 8, further comprising decrypting said content encrypted with said content key using a content key recovered from the multiple nested list of decryption patterns.

10. A method comprising:
generating a list of update keys on a key distribution center system based on a table of secret keys identifying valid and invalid receivers of a plurality of receivers, said list of update keys allowing valid receivers to decrypt a valid content key using update keys obtained from the list of update keys;
generating a multiple nested list of decryption patterns based on the list of update keys; and
broadcasting said multiple nested list of decryption patterns to the plurality of receivers.

11. The method of claim 10, wherein said generating a list of update keys comprises generating at least one intermediate key and one content key.

12. The method of claim 11, wherein said generating at least one intermediate key and one content key comprises randomly generating said at least one intermediate key and one content key.

13. The method of claim 10, wherein said generating a multiple nested list of decryption patterns comprises encrypting an entry of the list of update keys using a key that is a combination of a previous update key, a secret key for a receiver associated with the entry of the list of update keys, and an index indicating a location in said table of secret keys associated with each entry.

14. The method of claim 13, wherein an entry in said multiple nested list of decryption patterns includes a predetermined test pattern encrypted with the secret keys for a receiver associated with the entry of the list of update keys.

15. A method comprising:
receiving a multiple nested list of decryption patterns from a key distribution center system;
recovering a set of update keys from the multiple nested list of decryption patterns; and
recovering a content key from the list of update keys by using the set of update keys to decrypt the content key.

16. The method of claim 15, wherein said multiple nested list of decryption patterns comprises a list of update keys encrypted with a key that is a combination of a previous update key, a secret key for a receiver associated with an entry of the list of update keys, and an index value.

17. The method of claim 16, wherein an entry in said multiple nested list of decryption patterns includes a predetermined test pattern encrypted with secret keys for a receiver associated with the entry of the list of update keys.

18. The method of claim 15, wherein said recovering a set of update keys from the multiple nested list of decryption patterns comprises parsing said multiple nested list of decryption patterns to locate an entry intended for a particular receiver based on detection of a predetermined test pattern included in an entry in the multiple nested list of decryption patterns.

19. A system comprising:
a key distribution center to generate a list of update keys based on a table of secret keys identifying valid and invalid receivers of a plurality of receivers, said list of update keys allowing valid receivers of said plurality of receivers to decrypt a valid content key using update keys obtained from the list of update keys, generate a multiple nested list of decryption patterns based on the list of update keys, and broadcast said multiple nested list of decryption patterns to the plurality of receivers; and
a content receiver to recover an appropriate set of update keys from the multiple nested list of decryption patterns so that the final key recovered in the set of update keys is a content key.

20. The system of claim 19, wherein said key distribution center generates at least one intermediate key and one content key.

21. The system of claim 20, wherein said key distribution center randomly generates said at least one intermediate key and one content key.

22. The system of claim 21, wherein authorized receivers will receive an intermediate key that allows recovery of a valid content key and unauthorized receivers will receive an intermediate key that does not allow recovery of a valid content key.

23. The system of claim 19, wherein said key distribution center encrypts an entry of the list of update keys using a key that is a combination of a previous update key, a secret keys for a receiver associated with the entry of the list of update keys, and an index indicating a location in said table of secret keys associated with each entry to generate said multiple nested list of decryption patterns.

24. The system of claim 23, wherein an entry in said multiple nested list of decryption patterns includes a predetermined test pattern encrypted with the secret keys for a receiver associated with the entry of the list of update keys.

25. The system of claim 19, wherein said receiver parses said multiple nested list of decryption patterns to locate an entry intended for a particular receiver based on detection of a predetermined test pattern included in an entry in the multiple nested list of decryption patterns.

26. The system of claim 19, further comprising content provider to broadcast content encrypted with said content key.

27. The system of claim 26, wherein said receiver decrypts said content encrypted with said content key using a content key recovered from the multiple nested list of decryption patterns.

28. A machine-readable medium having stored thereon data representing sequences of instructions, the sequences of instructions which, when executed by a processor, cause the processor to:
generate a list of update keys on a key distribution center system based on a table of secret keys identifying valid and invalid receivers of a plurality of receivers, said list of update keys allowing valid receivers to decrypt a valid content key using update keys obtained from the list of update keys;
generate a multiple nested list of decryption patterns based on the list of update keys;
broadcast said multiple nested list of decryption patterns to the plurality of receivers;
recover a content key from the list of update keys by recovering an appropriate set of update keys for each receiver from the multiple nested list of decryption patterns and using the set of update keys to decrypt the content key.

29. The machine-readable medium of claim 28, wherein said generating a list of update keys comprises generating at least one intermediate key and one content key.

30. The machine-readable medium of claim 29, wherein said generating at least one intermediate key and one content key comprises randomly generating said at least one intermediate key and one content key.

31. The machine-readable medium of claim 30, wherein authorized receivers will receive an intermediate key that allows recovery of a valid content key and unauthorized receivers will receive an intermediate key that does not allow recovery of a valid content key.

32. The machine-readable medium of claim 28, wherein said generating a multiple nested list of decryption patterns comprises encrypting an entry of the list of update keys using a key that is a combination of a previous update key, a secret keys for a receiver associated with the entry of the list of update keys, and an index indicating a location in said table of secret keys associated with each entry.

33. The machine-readable medium of claim 32, wherein an entry in said multiple nested list of decryption patterns includes a predetermined test pattern encrypted with the secret keys for a receiver associated with the entry of the list of update keys.

34. The machine-readable medium of claim 28, wherein said recovering an appropriate set of update keys for each receiver from the multiple nested list of decryption patterns comprises parsing said multiple nested list of decryption patterns to locate an entry intended for a particular receiver based on detection of a predetermined test pattern included in an entry in the multiple nested list of decryption patterns.

35. The machine-readable medium of claim 28, further comprising broadcasting content encrypted with said content key.

36. The machine-readable medium of claim 35, further comprising decrypting said content encrypted with said content key using a content key recovered from the multiple nested list of decryption patterns.

37. A machine-readable medium having stored thereon data representing sequences of instructions, the sequences of instructions which, when executed by a processor, cause the processor to:
generate a list of update keys on a key distribution center system based on a table of secret keys identifying valid and invalid receivers of a plurality of receivers, said list of update keys allowing valid receivers to decrypt a valid content key using update keys obtained from the list of update keys;
generate a multiple nested list of decryption patterns based on the list of update keys; and
broadcast said multiple nested list of decryption patterns to the plurality of receivers.

38. The machine-readable medium of claim 37, wherein said generating a list of update keys comprises generating at least one intermediate key and one content key.

39. The machine-readable medium of claim 38, wherein said generating at least one intermediate key and one content key comprises randomly generating said at least one intermediate key and one content key.

40. The machine-readable medium of claim 37, wherein said generating a multiple nested list of decryption patterns comprises encrypting an entry of the list of update keys using a key that is a combination of a previous update key, a secret key for a receiver associated with the entry of the list of update keys, and an index indicating a location in said table of secret keys associated with each entry.

41. The machine-readable medium of claim 40, wherein an entry in said multiple nested list of decryption patterns includes a predetermined test pattern encrypted with the secret keys for a receiver associated with the entry of the list of update keys.

42. A machine-readable medium having stored thereon data representing sequences of instructions, the sequences of instructions which, when executed by a processor, cause the processor to:
receive a multiple nested list of decryption patterns from a key distribution center system;
recover a set of update keys from the multiple nested list of decryption patterns; and
recover a content key from the list of update keys by using the set of update keys to decrypt the content key.

43. The machine-readable medium of claim 42, wherein said multiple nested list of decryption patterns comprises a list of update keys encrypted with a key that is a combination of a previous update key, a secret key for a receiver associated with an entry of the list of update keys, and an index value.

44. The machine-readable medium of claim 43, wherein an entry in said multiple nested list of decryption patterns includes a predetermined test pattern encrypted with secret keys for a receiver associated with the entry of the list of update keys.

45. The machine-readable medium of claim 42, wherein said recovering a set of update keys from the multiple nested list of decryption patterns comprises parsing said multiple nested list of decryption patterns to locate an entry intended for a particular receiver based on detection of a predetermined test pattern included in an entry in the multiple nested list of decryption patterns.
